(19) United States
(12) Patent Application Publication
(10) Pub. No.: US 2010/0148905 A1
(43) Pub. Date: Jun. 17, 2010

(54) INDUCTOR MODULE AND CIRCUIT MODULE

(75) Inventor: Katsuji Matsumoto, Kanagawa (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: Sony Corporation, Tokyo (JP)

(21) Appl. No.: 12/625,320

(22) Filed: Nov. 24, 2009

(30) Foreign Application Priority Data
Dec. 16, 2008 (JP) 2008-319215

(51) Int. Cl. H01F 21/00

(52) U.S. Cl. 336/137

(57) ABSTRACT

Disclosed herein is an inductor module including a coil section provided with an input terminal and an output terminal. At least one of the input terminal and the output terminal is composed of a plurality of terminals. The input terminal and the output terminal are connected at different positions. The connection of the plurality of terminals constituting the input terminal or the output terminal is switched so as to change the combination of the input terminal and the output terminal, obtaining different inductance values.

The present application claims priority to Japanese Patent Application JP 2008-319215 filed with the Japanese Patent Office on Dec. 16, 2008, the entire content of which is hereby incorporated by reference.

### BACKGROUND OF THE INVENTION

1. Field of the Invention

The present invention relates to an inductor module and a circuit module, and more particularly to an inductor module provided with an inductor including a plurality of coil sections. The present invention relates also to a circuit module including a plurality of such inductors.

2. Description of the Related Art

A television tuner requires many components such as inductors, and there is a case that it is difficult to reduce the size of the apparatus.

Developed as the television tuner is a silicon tuner including a circuit module such that analog high-frequency circuits are integrated in a semiconductor such as Si and SiGe. The silicon tuner uses an inductor module such that a device such as an inductor is incorporated in a printed wiring board.

For example, a flat coil is used as the inductor (see Japanese Patent Laid-open Nos. 2004-6515 and 2008-41833, for example).

### SUMMARY OF THE INVENTION

A television tuner is required to support a wide frequency band from tens of MHz to 1 GHz. Accordingly, there is a case that a plurality of inductors having different inductance values are required.

To meet this requirement, there are provided a plurality of kinds of inductors different in the number of layers of flat coils or in the number of turns of coils, for example. In such a case, the footprint of the inductors is therefore increased and there is a case that it is difficult to reduce the size of the inductor module, causing a possible increase in cost.

There is accordingly a need for the present invention to provide an inductor module and a circuit module which can be reduced in size.

In accordance with an embodiment of the present invention, there is provided an inductor module including a coil section provided with an input terminal and an output terminal. At least one of the input terminal and the output terminal is composed of a plurality of terminals. The input terminal and the output terminal are connected at different positions. The connection of the plurality of terminals constituting the input terminal or the output terminal is switched so as to change the combination of the input terminal and the output terminal, thereby obtaining different inductance values.

In accordance with another embodiment of the present invention, there is provided a circuit module including an inductor having a coil section provided with an input terminal and an output terminal. At least one of the input terminal and the output terminal is composed of a plurality of terminals. The input terminal and the output terminal are connected at different positions. The connection of the plurality of terminals constituting the input terminal or the output terminal is switched so as to change the combination of the input terminal and the output terminal, thereby obtaining different inductance values.

According to the present embodiment, the coil section includes the input terminal and the output terminal, wherein at least one of the input terminal and the output terminal is composed of a plurality of terminals. The connection of the plural terminals constituting the input terminal or the output terminal is switched so as to change the combination of the input terminal and the output terminal. Accordingly, the path of a current to be passed through the coil section from the input terminal to the output terminal is changed to thereby obtain different inductance values in the inductor.

According to the present embodiment, it is possible to provide an inductor module and a circuit module which can be reduced in size.

Other objects and features of the invention will be more fully understood from the following detailed description and appended claims when taken with the accompanying drawings.

### BRIEF DESCRIPTION OF THE DRAWINGS

FIG. 1 is a schematic plan view showing a major part of a circuit module according to a first preferred embodiment of the present invention;

FIG. 2 is a schematic perspective view showing a major part of a first inductor according to the first preferred embodiment of the present invention;

FIGS. 3A and 3B are sectional views of the first inductor shown in FIG. 2;

FIGS. 4A to 7B are sectional views showing the steps of a manufacturing method for the first inductor according to the first preferred embodiment of the present invention;

FIG. 8 is a schematic perspective view showing a major part of a first inductor according to a second preferred embodiment of the present invention;

FIGS. 9A and 9B are sectional views of the first inductor shown in FIG. 8;

FIGS. 10A and 10B are sectional views showing a major part of a first inductor according to a third preferred embodiment of the present invention;

FIG. 11 is a schematic top plan view showing a major part of a first inductor according to a fourth preferred embodiment of the present invention; and

FIG. 12 is a sectional view of the first inductor shown in FIG. 11.

### DETAILED DESCRIPTION OF THE PREFERRED EMBODIMENTS

Some preferred embodiments of the present invention will now be described in detail with reference to the attached drawings. The preferred embodiments will be described in the following order.

1. First Preferred Embodiment (Inductor module having two output terminals)
2. Second Preferred Embodiment (Inductor module having three output terminals)
3. Third Preferred Embodiment (Inductor module having a magnetic insulating layer)
4. Fourth Preferred Embodiment (Inductor module having a solenoid coil)

### 5. Modifications

### 1. First Preferred Embodiment

### 1-1. Configuration

### (1-1-1. Configuration of Circuit Module)

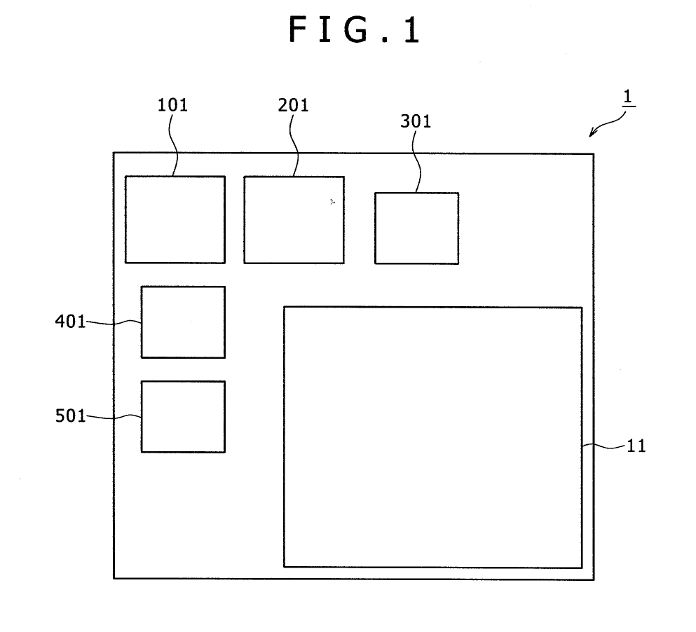

FIG. 1 is a schematic plan view showing the configuration of a major part of a circuit module 1 according to a first preferred embodiment of the present invention.

The circuit module 1 is used in a television tuner, for example. As shown in FIG. 1, the circuit module 1 includes an LSI section 11 and first to fifth inductors 101, 201, 301, 401, and 501.

### (1-1-2. Configuration of the First Inductor)

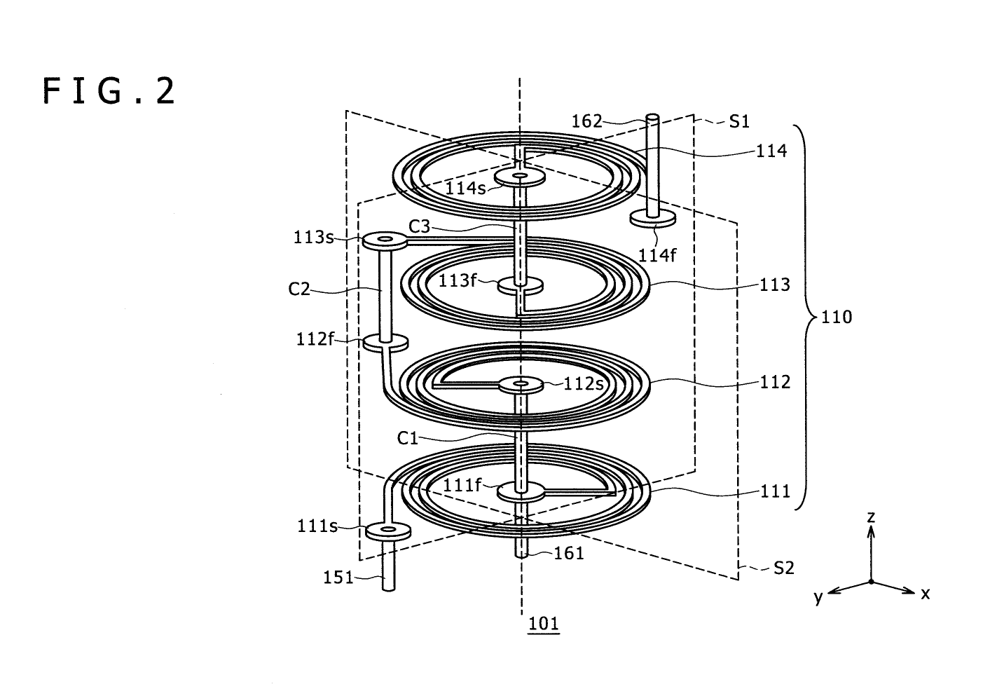

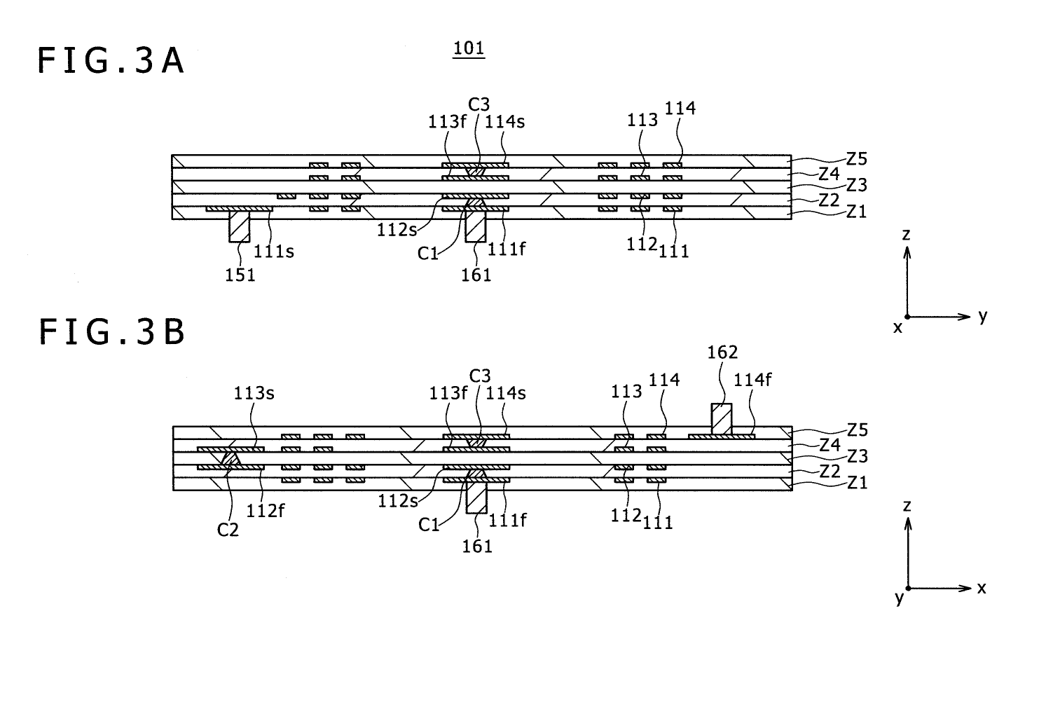

FIG. 2 and FIGS. 3A and 3B are schematic views showing the configuration of a major part of the first inductor 101 according to the first preferred embodiment of the present invention. More specifically, FIG. 2 is a perspective view of the first inductor 101, and FIGS. 3A and 3B are sectional views of the first inductor 101, wherein FIG. 3A is a cross section taken along a plane S1 (yz plane) shown in FIG. 2, and FIG. 3B is a cross section taken along a plane S2 (xz plane) shown in FIG. 2. In FIG. 2, only a major part of the first inductor 101 shown in FIGS. 3A and 3B is shown for convenience of illustration, and the other parts are not shown. Further, the parts shown in FIG. 2 and the parts shown in FIGS. 3A and 3B are suitably different in scale, aspect ratio, etc.

As shown in FIGS. 2, 3A, and 3B, the first inductor 101 includes a coil section 110, and the coil section 110 includes an input terminal 151, a first output terminal 161, and a second output terminal 162 connected to each other at different positions.

As described later in detail, the first inductor 101 is configured in such a manner that when a current is passed through the first inductor 101, the connection of the input terminal 151 and the plural output terminals 161 and 162 is changed in combination to thereby vary the value of an inductance. More specifically, the connection of the plural output terminals 161 and 162 is switched so that a current is passed either between the input terminal 151 and the first output terminal 161 or between the input terminal 151 and the second output terminal 162, thereby varying the inductance value.

The components of the first inductor 101 will now be described more specifically.

As shown in FIGS. 2, 3A, and 3B, the coil section 110 has a first coil pattern 111, a second coil pattern 112, a third coil pattern 113, and a fourth coil pattern 114.

The first to fourth coil patterns 111, 112, 113, and 114 constituting the coil section 110 are layered in this order from the lower side so as to be spaced apart from each other. Each of the first to fourth coil patterns 111 to 114 is formed of a conductive material such as metal.

As shown in FIGS. 3A and 3B, the first to fourth coil patterns 111 to 114 are so layered as to be sandwiched by a plurality of insulating layers Z1, Z2, Z3, Z4, and Z5. Each of the insulating layers Z1 to Z5 is formed of a nonmagnetic insulating material.

Further, as shown in FIG. 2, a plurality of blind via holes C1, C2, and C3 are provided between the first and second coil patterns 111 and 112, between the second and third coil patterns 112 and 113, and between the third and fourth coil patterns 113 and 114, respectively. Each of the blind via holes C1 to C3 is formed by filling a through hole with a conductive material such as metal, so that the first to fourth coil patterns 111 to 114 are electrically connected by the blind via holes C1, C2, and C3.

As shown in FIG. 2, the first coil pattern 111 of the coil section 110 is a spiral flat coil.

More specifically, as shown in FIG. 2, the first coil pattern 111 has a winding pattern extending spirally clockwise from one end 111s located at a radially outermost position to the other end 111f located at a radially central position.

As shown in FIGS. 3A and 3B, the first coil pattern 111 is sandwiched between the insulating layers Z1 and Z2.

As shown in FIG. 2, the input terminal 151 is provided on the lower surface of the one end 111s of the first coil pattern 111.

On the other hand, as shown in FIG. 2, the first output terminal 161 is provided on the lower surface of the other end 111f of the first coil pattern 111. Further, the blind via hole C1 is provided on the upper surface of the other end 111f of the first coil pattern 111.

As shown in FIG. 2, the second coil pattern 112 of the coil pattern 110 is also a spiral flat coil similar to the first coil pattern 111. The lower coil surface of the second coil pattern 112 is opposed to the upper coil surface of the first coil pattern 111.

More specifically, as shown in FIG. 2, the second coil pattern 112 has a winding pattern extending spirally clockwise from one end 112s located at a radially central position to the other end 112f located at a radially outermost position unlike the winding pattern of the first coil pattern 111.

As shown in FIGS. 3A and 3B, the second coil pattern 112 is sandwiched between the insulating layers Z2 and Z3.

The second coil pattern 112 is layered over the first coil pattern 111 in the condition where the insulating layer Z2 is interposed therebetween. That is, the lower surface of the second coil pattern 112 is opposed to the upper surface of the first coil pattern 111.

As shown in FIGS. 2, 3A, and 3B, the blind via hole C1 is provided on the lower surface of the one end 112s of the second coil pattern 112.

On the other hand, as shown in FIG. 2, the blind via hole C2 is provided on the upper surface of the other end 112f of the second coil pattern 112.

As shown in FIG. 2, the third coil pattern 113 of the coil section 110 is also a spiral flat coil similar to the first and second coil patterns 111 and 112. The lower coil surface of the third coil pattern 113 is opposed to the upper coil surface of the second coil pattern 112.

More specifically, as shown in FIG. 2, the third coil pattern 113 has a winding pattern extending spirally clockwise from one end 113s located at a radially outermost position to the other end 113f located at a radially central position like the winding pattern of the first coil pattern 111.

As shown in FIGS. 3A and 3B, the third coil pattern 113 is sandwiched between the insulating layers Z3 and Z4.

The third coil pattern 113 is layered over the second coil pattern 112 in the condition where the insulating layer Z3 is interposed therebetween. That is, the lower surface of the third coil pattern 113 is opposed to the upper surface of the second coil pattern 112.

As shown in FIGS. 2, 3A, and 3B, the blind via hole C2 is provided on the lower surface of the one end 113s of the third coil pattern 113.

On the other hand, as shown in FIG. 2, the blind via hole C3 is provided on the upper surface of the other end 113f of the third coil pattern 113.

As shown in FIG. 2, the fourth coil pattern 114 of the coil section 110 is also a spiral flat coil similar to the first to third coil patterns 111 to 113. The lower coil surface of the fourth coil pattern 114 is opposed to the upper coil surface of the third coil pattern 113.

More specifically, as shown in FIG. 2, the fourth coil pattern 114 has a winding pattern extending spirally clockwise from one end 114s located at a radially central position to the other end 114f located at a radially outermost position like the winding pattern of the second coil pattern 112.

As shown in FIGS. 3A and 3B, the fourth coil pattern 114 is sandwiched between the insulating layers Z3 and Z5.

The fourth coil pattern 114 is layered over the third coil pattern 113 in the condition where the insulating layer Z4 is interposed therebetween. That is, the lower surface of the fourth coil pattern 114 is opposed to the upper surface of the third coil pattern 113.

As shown in FIGS. 2, 3A, and 3B, the blind via hole C3 is provided on the lower surface of the one end 114s of the fourth coil pattern 114.

On the other hand, the second output terminal 162 is provided on the upper surface of the other end 114f of the fourth coil pattern 114.

As shown in FIGS. 2, 3A, and 3B, the input terminal 151 is provided on the lower surface of the first coil pattern 111 opposite to the second to fourth coil patterns 112, 113, and 114. The input terminal 151 is formed of a conductive material such as metal.

More specifically, the upper end surface of the input terminal 151 is connected to the lower surface of the one end 111s of the first coil pattern 111. Further, the input terminal 151 extends vertically downward from the lower surface of the one end 111s of the first coil pattern 111.

As shown in FIGS. 2, 3A, and 3B, the first output terminal 161 is provided on the lower surface of the first coil pattern 111 opposite to the second to fourth coil patterns 112, 113, and 114 like the input terminal 151. The first output terminal 161 is formed of a conductive material such as metal like the input terminal 151.

More specifically, the upper end surface of the first output terminal 161 is connected to the lower surface of the other end 111f of the first coil pattern 111. Further, the first output terminal 161 extends vertically downward from the lower surface of the other end 111f of the first coil pattern 111.

The second output terminal 162 is provided on the upper surface of the fourth coil pattern 114 opposite to the first to third coil patterns 111, 112, and 113. The second output terminal 162 is formed of a conductive material such as metal like the input terminal 151.

More specifically, the lower end surface of the second output terminal 162 is connected to the upper surface of the other end 114f of the fourth coil pattern 114. Further, the second output terminal 162 extends vertically upward from the upper surface of the other end 114f of the fourth coil pattern 114.

### 1-2. Operation

The operation of the first inductor 101 will now be described.

In the first inductor 101, the connection of the first and second output terminals 161 and 162 is switched so that a current is output from one of the first and second output terminals 161 and 162. More specifically, the connection between one of the first and second output terminals 161 and 162 and output wiring (not shown) through which an output current is passed is switched by a switching device (not shown).

Accordingly, in passing a current through the first inductor 101, either the combination of the input terminal 151 and the first output terminal 161 or the combination of the input terminal 151 and the second output terminal 162 is selected, so that the inductance value in the first inductor 101 is variable according to this selection.

More specifically, in the case that the connection is switched so that a current is input from the input terminal 151 and output from the first output terminal 161, the current is passed through the first coil pattern 111.

As shown in FIG. 2, the current input to the one end 111s of the first coil pattern 111 is passed clockwise toward the other end 111f of the first coil pattern 111 and next output from the first output terminal 161 provided at the other end 111f.

That is, the current is passed through only the first coil pattern 111 and no current is passed through the second to fourth coil patterns 112, 113, and 114.

In the case that the connection is switched so that a current is input from the input terminal 151 and output from the second output terminal 162, the current is passed not only through the first coil pattern 111, but also through the second to fourth coil patterns 112, 113, and 114.

As shown in FIG. 2, the current input to the one end 111s of the first coil pattern 111 is passed clockwise toward the other end 111f of the first coil pattern 111 and next input to the one end 112s of the second coil pattern 112. In the first coil pattern 111, the current input to the one end 111s is passed clockwise through the spiral winding to the other end 111f.

Thereafter, the current input to the one end 112s of the second coil pattern 112 is passed clockwise toward the other end 112f of the second coil pattern 112 and next input to the one end 113s of the third coil pattern 113. Also in the second coil pattern 112, the current input to the one end 112s is passed clockwise through the spiral winding to the other end 112f.

Thereafter, the current input to the one end 113s of the third coil pattern 113 is passed clockwise toward the other end 113f of the third coil pattern 113 and next input to the one end 114s of the fourth coil pattern 114. Also in the third coil pattern 113, the current input to the one end 113s is passed clockwise through the spiral winding to the other end 113f.

Thereafter, the current input to the one end 114s of the fourth coil pattern 114 is passed clockwise toward the other end 114f of the fourth coil pattern 114. Also in the fourth coil pattern 114, the current input to the one end 114s is passed clockwise through the spiral winding to the other end 114f.

Thereafter, the current input to the other end 114f of the fourth coil pattern 114 is output from the second output terminal 162 provided at the other end 114f.

In the former case that the current is output from the first output terminal 161 in the first inductor 101, a low, first inductance value is obtained.

In the latter case that the current is output from the second output terminal 162, a second inductance value higher than the first inductance value is obtained. That is, in the latter case, the current is passed through the first to fourth coil patterns 111 to 114 in the same direction (clockwise direction) and the number of turns of the coil passing the current is greater than that in the former case. As a result, the inductance value in the latter case is higher than that in the former case.

As described above, either the first output terminal 161 or the second output terminal 162 is connected to the output wiring. Accordingly, there is no possibility that devices having different inductance values are operated at the same time.

In the first inductor 101, two different inductance values can be selectively obtained, that is, either the first inductance value or the second inductance value higher than the first inductance value can be selected.

The positions of the first and second output terminals 161 and 162 in the first inductor 101 are merely illustrative and may be changed.

For example, the first output terminal 161 may be provided at the upper surface of the one end 114s of the fourth coil pattern 114. In this case, when a current is output from the first output terminal 161, the current is passed through the first to third coil patterns 111, 112, and 113. Accordingly, the inductance value in this case becomes higher than that in the above case where the first output terminal 161 is provided on the lower surface of the other end 111f of the first coil pattern 111.

The second to fifth inductors 201, 301, 401, and 501 are configured so as to provide inductance values different from the inductance value in the first inductor 101. Further, the inductance values in the second to fifth inductors 201 to 501 are fixed values unlike the variable inductance value in the first inductor 101.

However, each of the second to fifth inductors 201 to 501 may provide a plurality of different inductance values as in the first inductor 101.

### 1-3. Manufacturing Method

There will now be described a major part of a manufacturing method for the first inductor 101.

Although not shown, the second to fifth inductors 201 to 501 are also similarly manufactured by the manufacturing method for the first inductor 101.

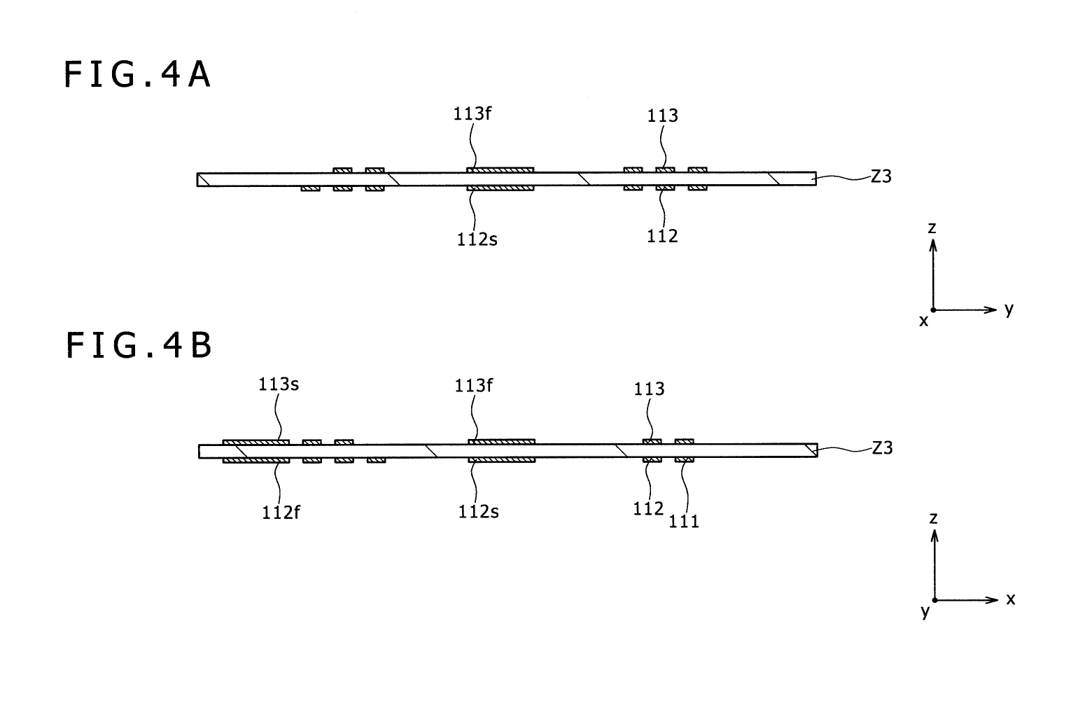

FIGS. 4A and 4B to FIGS. 7A and 7B show the steps of the manufacturing method for the first inductor 101. More specifically, FIGS. 4A, 5A, 6A, and 7A are cross sections taken along the plane S1 (yz plane) shown in FIG. 2, and FIGS. 4B, 5B, 6B, and 7B are cross sections taken along the plane S2 (xz plane) shown in FIG. 2.

### (1) Formation of the Second Coil Pattern 112 and the Third Coil Pattern 113

As shown in FIGS. 4A and 4B, the second coil pattern 112 and the third coil pattern 113 are first formed on both sides of the insulating layer Z3.

First, a laminated sheet (not shown) formed by laminating copper foils (not shown) on both sides of the insulating layer Z3 is prepared. The insulating layer Z3 is provided by an insulating resin substrate.

The copper foil laminated on one side of the insulating layer Z3 is patterned to form the second coil pattern 112.

More specifically, as shown in FIG. 2, the patterning for the second coil pattern 112 is performed so that the second coil pattern 112 has a winding pattern extending spirally clockwise from the one end 112s located at the radially central position toward the other end 112f located at the radially outermost position.

Similarly, the copper foil laminated on the other side of the insulating layer Z3 is patterned to form the third coil pattern 113.

More specifically, as shown in FIG. 2, the patterning for the third coil pattern 113 is performed so that the third coil pattern 113 has a winding pattern extending spirally clockwise from the one end 113s located at the radially outermost position toward the other end 113f located at the radially central position.

### (2) Formation of the Blind Via Hole C2

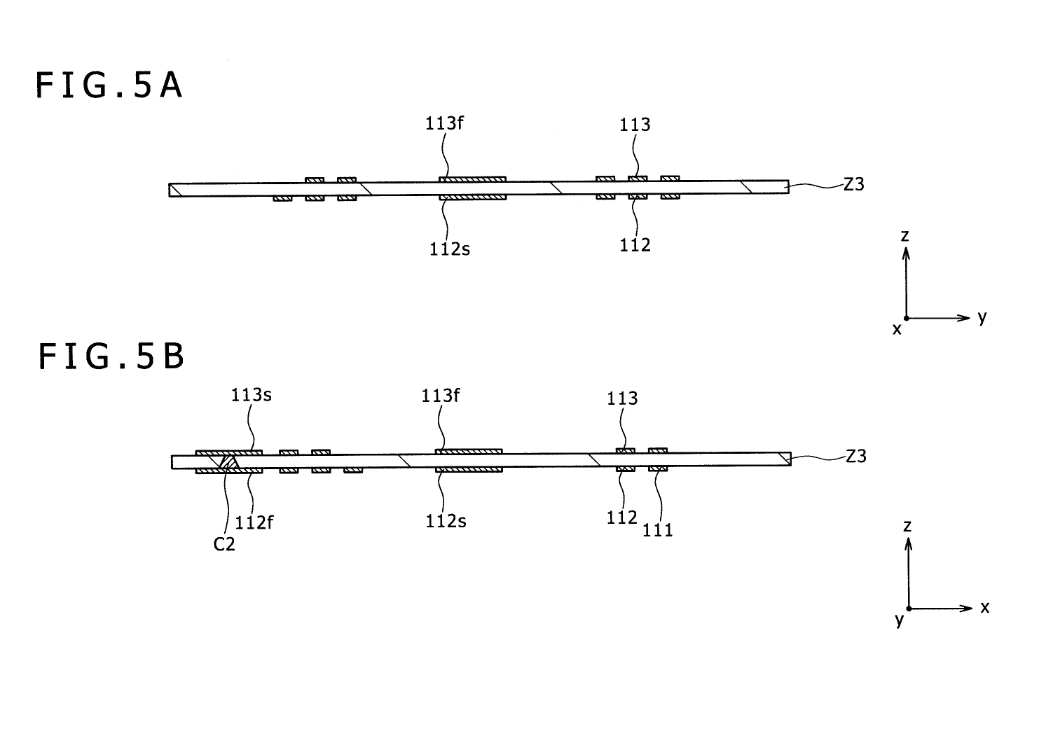

As shown in FIGS. 5A and 5B, the blind via hole C2 is next formed through the insulating layer Z3 so as to connect the second coil pattern 112 and the third coil pattern 113.

First, a through hole (not shown) is formed through the insulating layer Z3 by laser processing. For example, this laser processing is performed by using a carbon dioxide gas laser.

Thereafter, this through hole is filled with a conductive material such as metal to thereby form the blind via hole C2. For example, the filling of the through hole is performed by plating.

More specifically, the blind via hole C2 is formed at a position corresponding to the other end 112f of the second coil pattern 112 and the one end 113s of the third coil pattern 113.

Accordingly, the other end 112f of the second coil pattern 112 and the one end 113s of the third coil pattern 113 are electrically connected by the blind via hole C2.

### (3) Formation of the First Coil Pattern 111 and the Fourth Coil Pattern 114

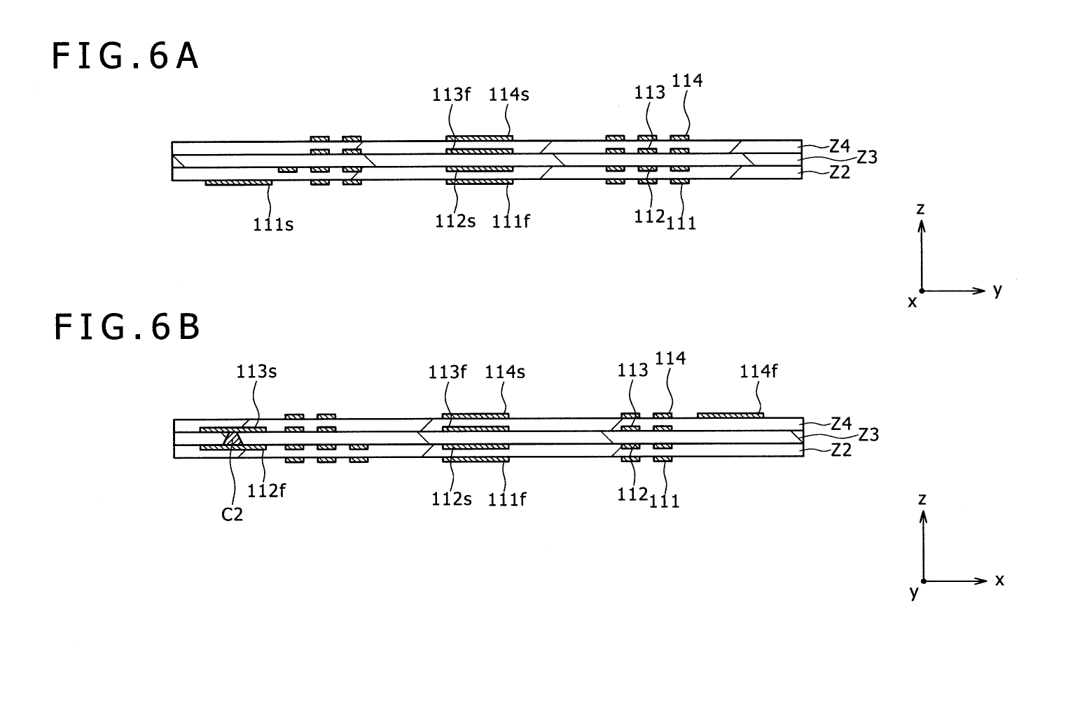

As shown in FIGS. 6A and 6B, the first coil pattern 111 and the fourth coil pattern 114 are next formed.

First, the insulating layers Z2 and Z4 are formed on both sides of the insulating layer Z3 on which the second coil pattern 112 and the third coil pattern 113 have already been formed. That is, the insulating layer Z2 is formed so as to cover the second coil pattern 112, and the insulating layer Z4 is formed so as to cover the third coil pattern 113. For example, the insulating layers Z2 and Z4 are formed by laminating resin-containing insulating prepreg films on both sides of the insulating layer Z3.

Thereafter, a copper foil (not shown) is laminated on one side (exposed surface) of the insulating layer Z2 and next patterned to form the first coil pattern 111.

More specifically, as shown in FIG. 2, the patterning for the first coil pattern 111 is performed so that the first coil pattern 111 has a winding pattern extending spirally clockwise from the one end 111s located at the radially outermost position toward the other end 111f located at the radially central position.

Similarly, a copper foil (not shown) is laminated on one side (exposed surface) of the insulating layer Z4 and next patterned to form the fourth coil pattern 114.

More specifically, as shown in FIG. 2, the patterning for the fourth coil pattern 114 is performed so that the fourth coil pattern 114 has a winding pattern extending spirally clockwise from the one end 114s located at the radially central position toward the other end 114f located at the radially outermost position.

### (4) Formation of the Blind Via Holes C1 and C3

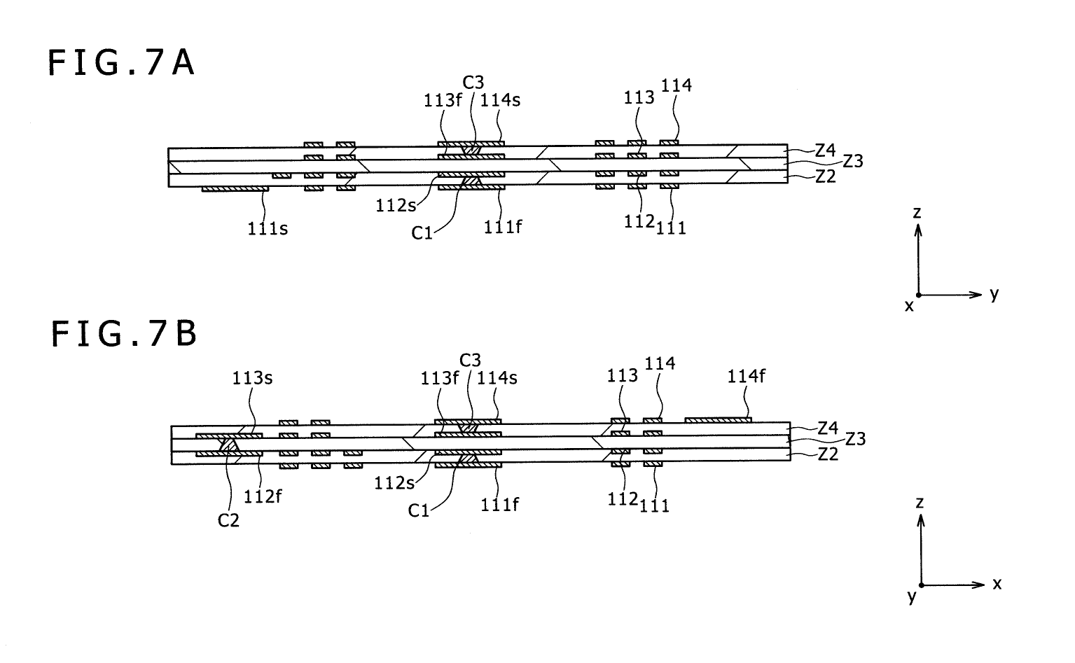

As shown in FIGS. 7A and 7B, the blind via holes C1 and C3 are next formed through the insulating layers Z2 and Z4, respectively, so as to connect the first coil pattern 111 and the second coil pattern 112 and connect the third coil pattern 113 and the fourth coil pattern 114.

First, a through hole (not shown) is formed through the insulating layer Z2 by laser processing. Thereafter, this through hole is filled with a conductive material such as metal to thereby form the blind via hole C1.

More specifically, the blind via hole C1 is formed at a position corresponding to the other end 111f of the first coil pattern 111 and the one end 112s of the second coil pattern 112.

Accordingly, the other end 111f of the first coil pattern 111 and the one end 112s of the second coil pattern 112 are electrically connected by the blind via hole C1.

Similarly, a through hole (not shown) is formed through the insulating layer Z4 by laser processing. Thereafter, this through hole is filled with a conductive material such as metal to thereby form the blind via hole C3.

More specifically, the blind via hole C3 is formed at a position corresponding to the other end 113f of the third coil pattern 113 and the one end 114s of the fourth coil pattern 114.

Accordingly, the other end 113f of the third coil pattern 113 and the one end 114s of the fourth coil pattern 114 are electrically connected by the blind via hole C3.

### (5) Formation of the Input Terminal 151 and the First and Second Output Terminals 161 and 162

As shown in FIGS. 3A and 3B, the input terminal 151 and the first and second output terminals 161 and 162 are next formed.

First, the insulating layer Z1 is formed on one side (exposed surface) of the insulating layer Z2, and the insulating layer Z5 is formed on one side (exposed surface) of the insulating layer Z4. That is, the insulating layer Z1 is formed so as to cover the first coil pattern 111, and the insulating layer Z5 is formed so as to cover the fourth coil pattern 114. For example, the insulating layer Z1 is formed by laminating a resin-containing insulating prepreg film on one side (exposed surface) of the insulating layer Z2. Similarly, the insulating layer Z5 is formed by laminating a resin-containing insulating prepreg film on one side (exposed surface) of the insulating layer Z4.

Thereafter, two through holes (not shown) are formed through the insulating layer Z1 by laser processing. These through holes are next filled with a conductive material such as metal to thereby form the input terminal 151 and the first output terminal 161.

More specifically, the input terminal 151 is formed at a position corresponding to the one end 111s of the first coil pattern 111, and the first output terminal 161 is formed at a position corresponding to the other end 111f of the first coil pattern 111.

Similarly, a through hole (not shown) is formed through the insulating layer Z5 by laser processing. This through hole is next filled with a conductive material such as metal to thereby form the second output terminal 162.

More specifically, the second output terminal 162 is formed at a position corresponding to the other end 114f of the fourth coil pattern 114.

Thus, the first inductor 101 is completed.

The above-mentioned steps of the manufacturing method for the first inductor 101 are merely illustrative and various other methods used in the manufacture of a printed wiring board may be applied.

### 1-4. Summary

In this preferred embodiment, the coil section 110 includes three terminals, i.e., the input terminal 151 and the first and second output terminals 161 and 162, which are connected at different positions. The connection to one of the plural output terminals 161 and 162 is selected so as to change the combination of the input terminal 151 and the plural output terminals 161 and 162. Accordingly, the inductance value in the first inductor 101 can be varied.

Accordingly, it is unnecessary to provide a plurality of inductors for supporting a plurality of different inductance values, so that the footprint of an inductor can be reduced. As a result, the module including the inductor in this preferred embodiment can be reduced in size.

Further, in this preferred embodiment, each of the first to fourth coil patterns 111 to 114 is a flat coil and these coil patterns 111 to 114 are layered so that the respective coil surfaces are opposed to each other. The input terminal 151 is provided on the lower surface of the one end 111s of the first coil pattern 111 forming the lowermost layer. Further, the first output terminal 161 is provided on the lower surface of the other end 111f of the first coil pattern 111 forming the lowermost layer. Further, the second output terminal 162 is provided on the upper surface of the other end 114f of the fourth coil pattern 114 forming the uppermost layer.

Accordingly, the footprint of the inductor can be further reduced, so that the module including the inductor can be easily reduced in size.

### 2. Second Preferred Embodiment

A second preferred embodiment of the present invention will now be described.

### 2-1. Configuration

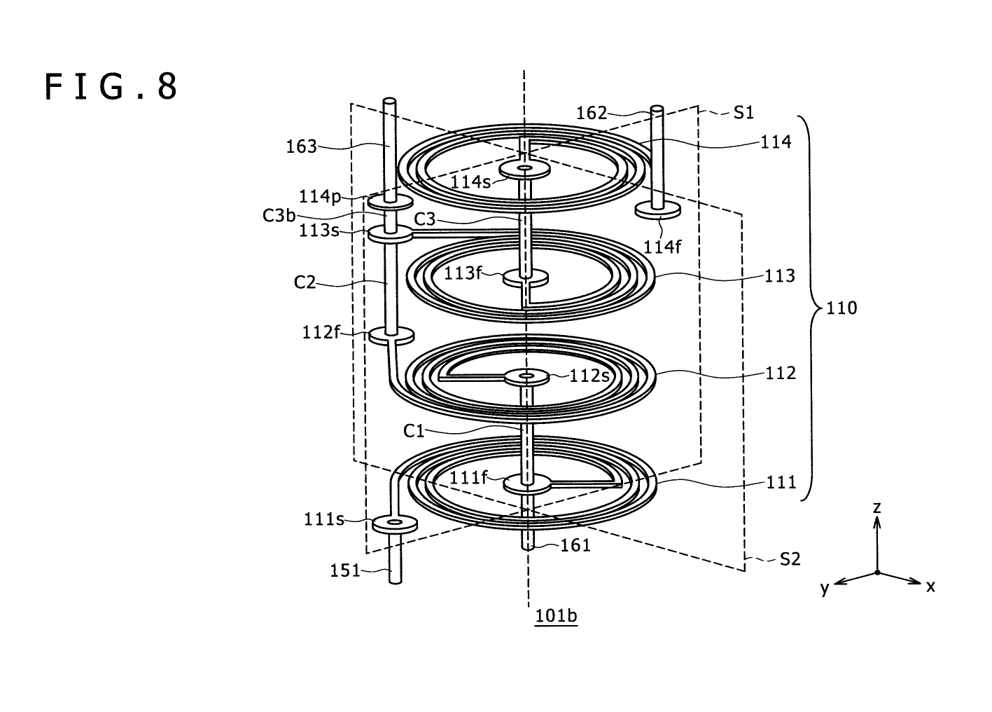

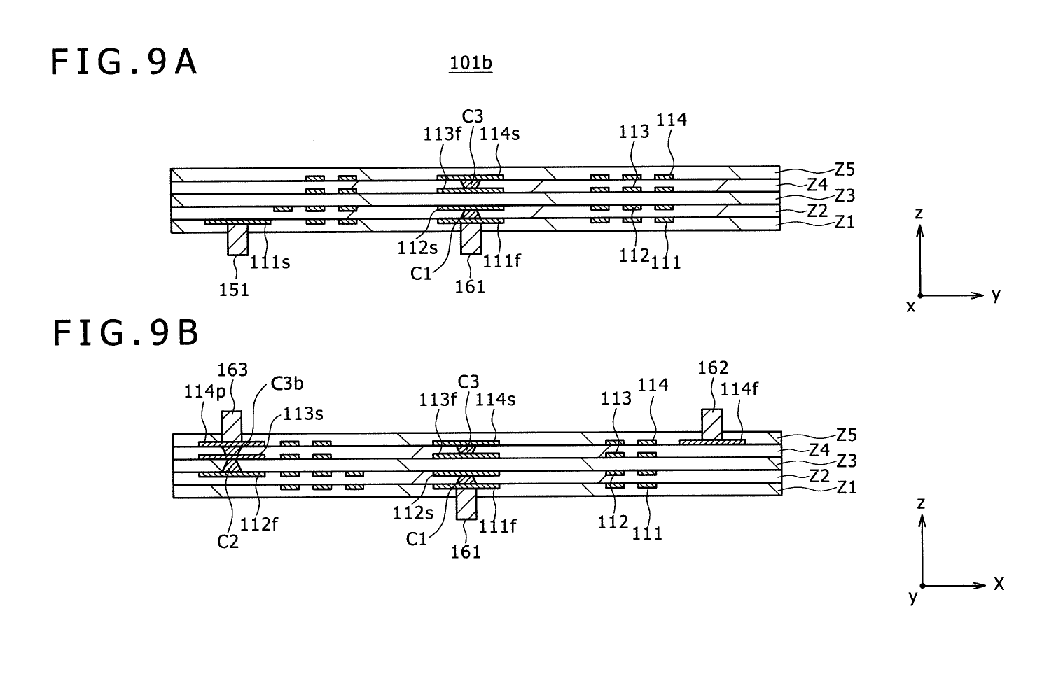

FIG. 8 and FIGS. 9A and 9B are schematic views showing the configuration of a major part of a first inductor 101b according to a second preferred embodiment of the present invention. More specifically, FIG. 8 is a perspective view of the first inductor 101b, and FIGS. 9A and 9B are sectional views of the first inductor 101b, wherein FIG. 9A is a cross section taken along a plane S1 (yz plane) shown in FIG. 8, and FIG. 9B is a cross section taken along a plane S2 (xz plane) shown in FIG. 8. In FIG. 8, only a major part of the first inductor 101b shown in FIGS. 9A and 9B is shown for convenience of illustration, and the other parts are not shown. Further, the parts shown in FIG. 8 and the parts shown in FIGS. 9A and 9B are suitably different in scale, aspect ratio, etc.

As shown in FIGS. 8, 9A, and 9B, the first inductor 101b additionally includes a third output terminal 163 as compared with the first inductor 101 according to the first preferred embodiment mentioned above. That is, the coil section 110 in the first inductor 101b includes the third output terminal 163 in addition to the input terminal 151 and the first and second output terminals 161 and 162, wherein these terminals 151, 161, 162, and 163 are electrically connected. Except this point and its related point, the second preferred embodiment is similar to the first preferred embodiment, and the description of the similar parts will therefore be omitted.

As shown in FIGS. 8, 9A, and 9B, a pad portion 114p is formed in the same layer as that of the fourth coil pattern 114, and the third output terminal 163 is provided on the upper surface of the pad portion 114p. That is, the lower end surface of the third output terminal 163 is connected to the upper surface of the pad portion 114p. The third output terminal 163 extends vertically upward from the pad portion 114p. The third output terminal 163 is formed of a conductive material such as metal like the input terminal 151.

The pad portion 114p is formed of a conductive material such as metal like the fourth coil pattern 114. The pad portion 114p is formed in the step of patterning a conductive film to form the fourth coil pattern 114.

A blind via hole C3b is provided on the lower surface of the pad portion 114p. The blind via hole C3b is formed by using a conductive material such as metal, and extends downward from the lower surface of the pad portion 114p. Further, the lower end surface of the blind via hole C3b is connected to the upper surface of the one end 113s of the third coil pattern 113.

That is, the third output terminal 163 is electrically connected through the pad portion 114p and the blind via hole C3b to the one end 113s of the third coil pattern 113.

### 2-2. Operation

The operation of the first inductor 101b will now be described.

In this preferred embodiment, the connection of the first, second, and third output terminals 161, 162, and 163 is switched so that a current is output from one of these output terminals 161 to 163. More specifically, the connection between one of the first to third output terminals 161 to 163 and output wiring (not shown) through which an output current is passed is switched by a switching device (not shown).

Accordingly, in passing a current through the first inductor 101b, one of the combination of the input terminal 151 and the first output terminal 161, the combination of the input terminal 151 and the second output terminal 162, and the combination of the input terminal 151 and the third output terminal 163 is selected, so that three different inductance values can be obtained in the first inductor 101b.

More specifically, in the case that the connection is switched so that a current is input from the input terminal 151 and output from the third output terminal 163, the current is passed through the first and second coil patterns 111 and 112.

The current input to the one end 111s of the first coil pattern 111 is passed through the spiral winding of the first coil pattern 111, the other end 111f of the first coil pattern 111, the blind via hole C1, the one end 112s of the second coil pattern 112, the spiral winding of the second coil pattern 112, the other end 112f of the second coil pattern 112, and the blind via hole C2 to the one end 113s of the third coil pattern 113 in this order.

Thereafter, the current input to the one end 113s of the third coil pattern 113 is passed through the blind via hole C3b to the pad portion 114p and next output from the third output terminal 163.

Accordingly, in the case that the current is output from the third output terminal 163 in the first inductor 101b, the inductance value becomes different from those obtained in the other two cases described in the first preferred embodiment.

That is, in the first inductor 101b, three different inductance values can be selectively obtained.

### 2-3. Summary

In this preferred embodiment, the coil section 110 includes four terminals, i.e., the input terminal 151 and the first to third output terminals 161 to 163, which are connected at different positions. The connection to one of the plural output terminals 161 to 163 is selected so as to change the combination of the input terminal 151 and the plural output terminals 161 to 163. Accordingly, the inductance value in the first inductor 101b can be varied.

Accordingly, as in the first preferred embodiment, it is unnecessary to provide a plurality of inductors for supporting a plurality of different inductance values, so that the footprint of an inductor can be reduced. As a result, the module including the inductor in this preferred embodiment can be reduced in size.

### 3. Third Preferred Embodiment

A third preferred embodiment of the present invention will now be described.

### 3-1. Configuration

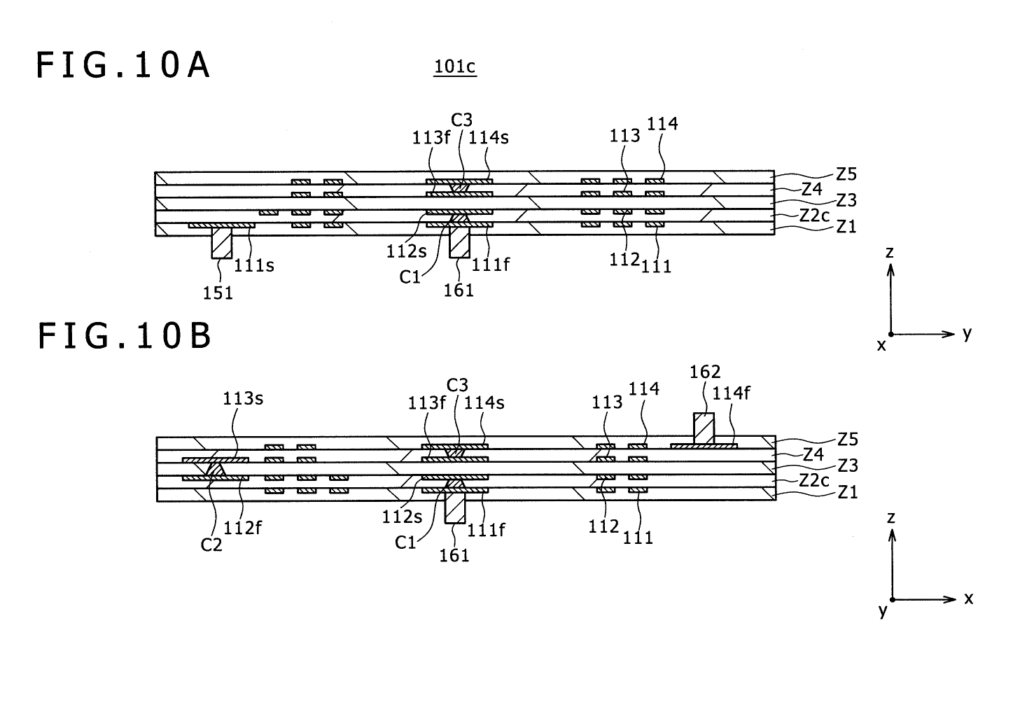

FIGS. 10A and 10B are schematic views showing the configuration of a major part of a first inductor 101c according to a third preferred embodiment of the present invention. More specifically, FIGS. 10A and 10B are sectional views of the first inductor 101c, wherein FIG. 10A is a cross section corresponding to that taken along the plane S1 (yz plane) shown in FIG. 2, and FIG. 10B is a cross section corresponding to that taken along the plane S2 (xz plane) shown in FIG. 2.

As shown in FIGS. 10A and 10B, the first inductor 101c is similar to the first inductor 101 according to the first preferred embodiment except that an insulating layer Z2c is provided in place of the insulating layer Z2. The description of the other similar parts will therefore be omitted.

The insulating layer Z2c interposed between the first coil pattern 111 and the second coil pattern 112 is formed of a magnetic material rather than a nonmagnetic material.

For example, the insulating layer Z2c is formed by mixing magnetic powder such as ferrite powder with resin such as epoxy resin and polyimide.

For example, the magnetic powder is selected from MnZn ferrite, NiZn ferrite, NiZnCu ferrite, Ba ferrite, CoFe soft magnetic alloy, Fe soft magnetic alloy, Co soft magnetic alloy, NiFe soft magnetic alloy, and the combination thereof.

### 3-2. Summary

In this preferred embodiment, the insulating layer Z2c formed of a magnetic material is provided between the first output terminal 161 and the second output terminal 162. Accordingly, in outputting a current from the first output terminal 161, it is possible to prevent the losses due to eddy currents caused by the second to fourth coil patterns 112 to 114 located in the layers above the first output terminal 161.

While the magnetic insulating layer Z2c is formed by mixing magnetic powder with resin in this preferred embodiment, this configuration is merely illustrative. For example, the magnetic insulating layer Z2c may be formed by laminating a magnetic substrate.

### 4. Fourth Preferred Embodiment

A fourth preferred embodiment of the present invention will now be described.

### 4-1. Configuration

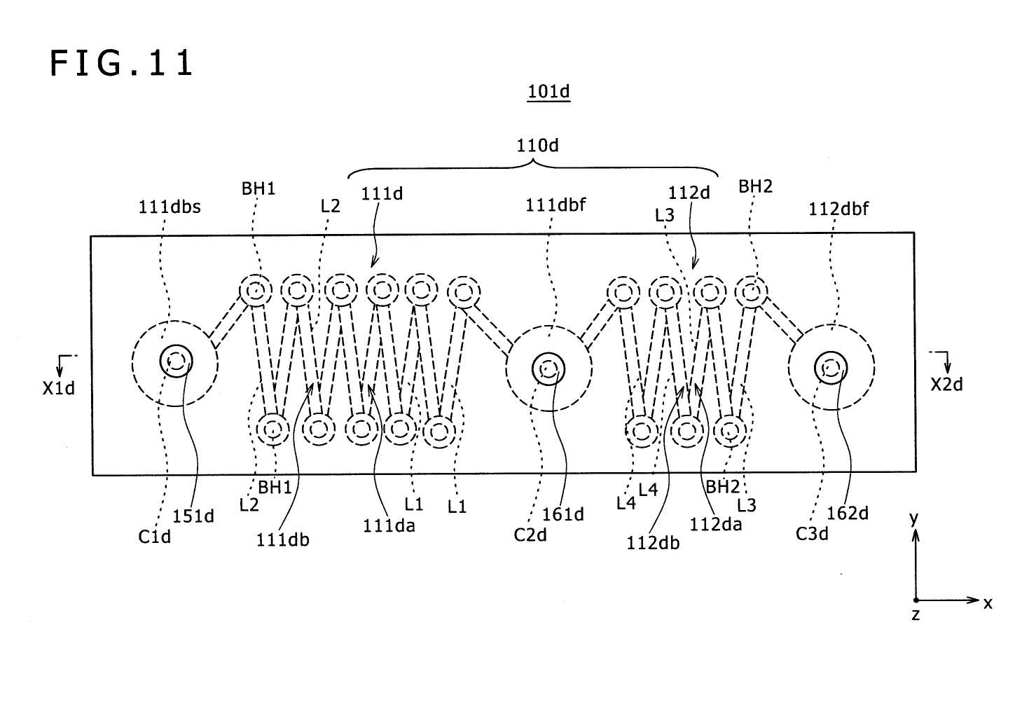

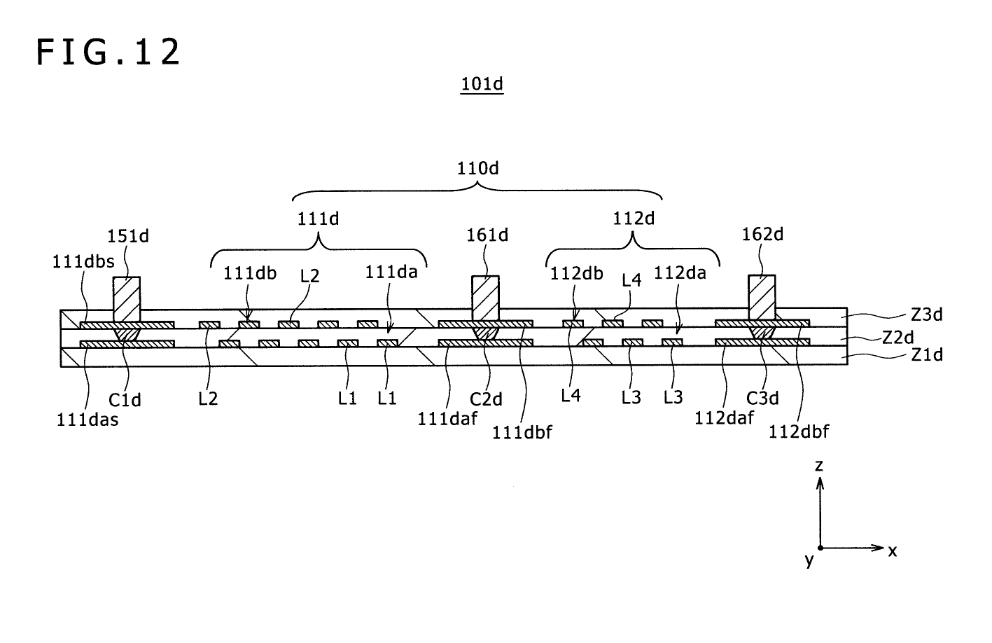

FIGS. 11 and 12 are schematic views showing the configuration of a major part of a first inductor 101d according to a fourth preferred embodiment of the present invention. More specifically, FIG. 11 is a top plan view of the first inductor 101d, and FIG. 12 is a sectional view of the first inductor 101d, that is, a cross section taken along the line X1d-X2d in FIG. 11.

As shown in FIGS. 11 and 12, the first inductor 101d includes a coil section 110d, and the coil section 110d includes an input terminal 151d, a first output terminal 161d, and a second output terminal 162d connected to each other at different positions.

As in the first preferred embodiment, the first inductor 101d is configured in such a manner that when a current is passed through the first inductor 101d, the connection of the input terminal 151d and the plural output terminals 161d and 162d is changed in combination to thereby vary the inductance value.

The components of the first inductor 101d will now be described more specifically.

As shown in FIGS. 11 and 12, the coil section 110d includes a first coil 111d and a second coil 112d.

The first and second coils 111d and 112d constituting the coil section 110d are arranged side by side in the x direction. Each of the first and second coils 111d and 112d is formed of a conductive material such as metal.

As shown in FIGS. 11 and 12, the first coil 111d has a solenoid-like winding embedded in a plurality of insulating layers Z1d, Z2d, and Z3d. Each of these insulating layers Z1d, Z2d, and Z3d is formed of a nonmagnetic insulating material.

More specifically, the first coil 111d includes a first coil pattern 111da and a second coil pattern 111db.

As shown in FIG. 12, the first coil pattern 111da of the first coil 111d is provided between the insulating layers Z1d and Z2d.

The first coil pattern 111da includes a plurality of line patterns L1. As shown in FIG. 11, these line patterns L1 extend in the xy plane so as to be inclined with respect to the x direction and the y direction.

As shown in FIG. 12, the first coil pattern 111da has one end 111das and the other end 111daf located at opposite positions in the x direction. The lower end surface of a blind via hole C1d is connected to the upper surface of the one end 111das of the first coil pattern 111da.

Similarly, the lower end surface of a blind via hole C2d is connected to the upper surface of the other end 111daf of the first coil pattern 111da.

As shown in FIG. 12, the second coil pattern 111db of the first coil 111d is provided between the insulating layers Z2d and Z3d.

The second coil pattern 111db includes a plurality of line patterns L2. As shown in FIG. 11, these line patterns L2 extend in the xy plane so as to be inclined with respect to the x direction and the y direction.

As shown in FIG. 11, each line pattern L2 of the second coil pattern 111db is connected at its opposite ends through via holes BH1 to the adjacent line patterns L1 of the first coil pattern 111da.

As shown in FIGS. 11 and 12, the second coil pattern 111db has one end 111dbs and the other end 111dbf located at opposite positions in the x direction. The upper end surface of the blind via hole C1d is connected to the lower surface of the one end 111dbs of the second coil pattern 111db, and the lower end surface of the input terminal 151d is connected to the upper surface of the one end 111dbs of the second coil pattern 111db.

Similarly, the upper end surface of the blind via hole C2d is connected to the lower surface of the other end 111dbf of the second coil pattern 111db, and the lower end surface of the first output terminal 161d is connected to the upper surface of the other end 111dbf of the second coil pattern 111db.

On the other hand, as shown in FIGS. 11 and 12, the second coil 112d also has a solenoid-like winding.

More specifically, the second coil 112d includes a third coil pattern 112da and a fourth coil pattern 112db.

As shown in FIG. 12, the third coil pattern 112da of the second coil 112d is provided between the insulating layers Z1d and Z2d like the first coil pattern 111da.

The third coil pattern 112da includes a plurality of line patterns L3. As shown in FIG. 11, these line patterns L3 extend in the xy plane so as to be inclined with respect to the x direction and the y direction.

As shown in FIGS. 11 and 12, the third coil pattern 112da has one end and the other end 112daf located at opposite positions in the x direction. The one end of the third coil pattern 112da is connected to the other end 111daf of the first coil pattern 111da.

The lower end surface of a blind via hole C3d is connected to the upper surface of the other end 112daf of the third coil pattern 112da.

As shown in FIG. 12, the fourth coil pattern 112db of the second coil 112d is provided between the insulating layers Z2d and Z3d like the second coil pattern 111db.

The fourth coil pattern 112db includes a plurality of line patterns L4. As shown in FIG. 11, these line patterns L4 extend in the xy plane so as to be inclined with respect to the x direction and the y direction.

As shown in FIG. 11, each line pattern L4 of the fourth coil pattern 112db is connected at its opposite ends through via holes BH2 to the adjacent line patterns L3 of the third coil pattern 112da.

As shown in FIGS. 11 and 12, the fourth coil pattern 112db has one end and the other end 112dbf located at opposite positions in the x direction. The one end of the fourth coil pattern 112db is connected to the third coil pattern 112da.

The upper end surface of the blind via hole C3d is connected to the lower surface of the other end 112dbf of the fourth coil pattern 112db, and the lower end surface of the second output terminal 162d is connected to the upper surface of the other end 112dbf of the fourth coil pattern 112db.

### 4-2. Operation

The operation of the first inductor 101d will now be described.

In the first inductor 101d, the connection of the first and second output terminals 161d and 162d is switched so that a current is output from one of the first and second output terminals 161d and 162d. More specifically, the connection between one of the first and second output terminals 161d and 162d and output wiring (not shown) through which an output current is passed is switched by a switching device (not shown).

Accordingly, in passing a current through the first inductor 101d, either the combination of the input terminal 151d and the first output terminal 161d or the combination of the input terminal 151d and the second output terminal 162d is selected, so that the inductance value in the first inductor 101d is variable according to this selection.

More specifically, in the case that the connection is switched so that a current is input from the input terminal 151d and output from the first output terminal 161d, the current is passed through the first coil 111d.

That is, the current is passed through only the first coil 111d and no current is passed through the second coil 112d.

More specifically, the current input to the one end 111dbs is passed through the first and second coil patterns 111da and 111db toward the other end 111dbf so as to form a cylindrical spiral about an axis extending in the x direction. The current is next output from the first output terminal 161d provided at the other end 111dbf.

In the case that the connection is switched so that a current is input from the input terminal 151d and output from the second output terminal 162d, the current is passed not only through the first coil 111d, but also through the second coil 112d.

More specifically, the current input to the one end 111dbs is passed through the first and second coil patterns 111da and 111db toward the other end 111dbf as in the above case. Thereafter, the current is passed through the blind via hole C2d to the other end 111daf of the first coil pattern 111da, which is connected to the one end of the third coil pattern 112da of the second coil 112d. Accordingly, the current is further passed through the third and fourth coil patterns 112da and 112db toward the other end 112dbf so as to form a cylindrical spiral about an axis extending in the x direction. The current is next output from the second output terminal 162d.

Accordingly, in the first inductor 101d, a first inductance value and a second inductance value different from the first inductance value can be selectively obtained.

### 4-3. Summary

In this preferred embodiment, the coil section 110d includes the input terminal 151d and the plural output terminals 161d and 162d, which are connected at different positions. The connection to one of the plural output terminals 161d and 162d is selected so as to change the combination of the input terminal 151d and the plural output terminals 161d and 162d. Accordingly, the inductance value in the first inductor 101d can be varied.

Accordingly, as in the first preferred embodiment, it is unnecessary to provide a plurality of inductors for supporting a plurality of different inductance values, so that the footprint of an inductor can be reduced. As a result, the module including the inductor in this preferred embodiment can be reduced in size.

### 5. Modifications

The present invention is not limited to the above preferred embodiments, but various modifications may be made.

For example, while the current is passed through the plural coil patterns (or coils) constituting the coil section in the same direction, i.e., in the clockwise direction in the above preferred embodiments, the present invention is not limited to this configuration. That is, the current may be passed through the plural coil patterns in different directions. In other words, the current may be passed through the plural coil patterns in the clockwise and counterclockwise directions. In this case, the inductance value is reduced.

While one input terminal is provided in each preferred embodiment mentioned above, the present invention is not limited to this configuration. That is, a plurality of input terminals may be provided and the connection of these plural input terminals may be switched. In the case that at least three terminals are located at different positions in the coil section and that two of these plural terminals are used as the input terminals or the output terminals, the combination of the input terminals and the output terminals may be arbitrarily changed.

Further, the number of layers forming the coil patterns may be arbitrarily selected.

The first coil pattern 111 in the first to third preferred embodiments corresponds to the first coil in the present invention. The second, third, and fourth coil patterns 112, 113, and 114 in the first to third preferred embodiments correspond to the second coil in the present invention. The first coil 111d in the fourth preferred embodiment corresponds to the first coil in the present invention, and the second coil 112d in the fourth preferred embodiment corresponds to the second coil in the present invention. The input terminal 151 or 151d in the above preferred embodiments corresponds to the input terminal in the present invention. The first output terminal 161 or 161d, the second output terminal 162 or 162d, and the third output terminal 163 in the above preferred embodiments correspond to the output terminal in the present invention. The coil section 110 or 110d in the above preferred embodiments corresponds to the coil section in the present invention. The insulating layer Z2c in the third preferred embodiment corresponds to the magnetic insulating layer in the present invention.

The present application contains subject matter related to that disclosed in Japanese Priority Patent Application JP 2008-319215 filed with the Japan Patent Office on Dec. 16, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An inductor module, comprising
a coil section provided with an input terminal and an output terminal, at least one of said input terminal and said output terminal being composed of a plurality of terminals, said input terminal and said output terminal being connected at different positions,
the connection of said plurality of terminals constituting said input terminal or said output terminal being switched so as to change the combination of said input terminal and said output terminal, obtaining different inductance values.

2. The inductor module according to claim 1, wherein
said coil section comprises a first coil and a second coil;
at least one of said plurality of terminals constituting said input terminal is provided at one end of said first coil;
one end of said second coil is electrically connected to the other end of said first coil; and
at least one of said plurality of terminals constituting said output terminal is provided at the other end of said second coil.

3. The inductor module according to claim 2, wherein
each of said first and second coils is provided by a flat coil having a first coil surface and a second coil surface opposite to each other, said first and second coils are layered so that said second coil surface of said first coil is opposed to said first coil surface of said second coil;
at least one of said plurality of terminals constituting said input terminal is provided on said first coil surface of said first coil opposite to said second coil; and
at least one of said plurality of terminals constituting said output terminal is provided on said second coil surface of said second coil opposite to said first coil.

4. The inductor module according to claim 3, wherein a magnetic insulating layer is formed between said first coil and said second coil.

5. The inductor module according to claim 4, wherein said magnetic insulating layer is formed by mixing magnetic powder with resin.

6. The inductor module according to claim 5, wherein said magnetic powder is selected from the group consisting of MnZn ferrite, NiZn ferrite, NiZnCu ferrite, Ba ferrite, CoFe soft magnetic alloy, Fe soft magnetic alloy, Co soft magnetic alloy, and NiFe soft magnetic alloy.

7. A circuit module, comprising
an inductor having a coil section provided with an input terminal and an output terminal, at least one of said input terminal and said output terminal being composed of a plurality of terminals, said input terminal and said output terminal being connected at different positions,
the connection of said plurality of terminals constituting said input terminal or said output terminal being switched so as to change the combination of said input terminal and said output terminal, obtaining different inductance values.

8. An inductor module, comprising
coil means provided with an input terminal and an output terminal, at least one of said input terminal and said output terminal being composed of a plurality of terminals, said input terminal and said output terminal being connected at different positions,
the connection of said plurality of terminals constituting said input terminal or said output terminal being switched so as to change the combination of said input terminal and said output terminal, obtaining different inductance values.
